(19) United States
(12) Patent Application Publication
(10) Pub. No.: US 2024/0340246 A1
(43) Pub. Date: Oct. 10, 2024

(54) COMMUNICATIONS TRAFFIC MANAGER

(71) Applicant: DJ Inventions, LLC, Houston, TX (US)

(72) Inventors: Douglas C. Osburn, III, Houston, TX (US); David Christopher Blanco, Houston, TX (US); Edgar Adrian Cantu Muñoz, Houston, TX (US)

(21) Appl. No.: 18/747,990

(22) Filed: Jun. 19, 2024

Related U.S. Application Data
(63) Continuation-in-part of application No. 16/660,255, filed on Oct. 22, 2019.

(51) Int. Cl. H04L 47/2425; H04L 12/66

(52) U.S. Cl. CPC H04L 47/2433; H04L 12/66

(57) ABSTRACT

A method and system for implementing a gateway protocol to prioritize incoming communications. It is implementable with software or hardware, and enables a simple, binary priority to be established for incoming communications. The method and system can provide a low-cost alternative to replacing legacy equipment currently in use, while allowing for updated and modernized functionality.

### CROSS REFERENCE TO RELATED APPLICATIONS

The present application is a Continuation in Part and claims priority to and the benefit of co-pending U.S. patent application Ser. No. 16/660,255 filed on Oct. 22, 2019, titled “COMMUNICATIONS TRAFFIC MANAGER.” This reference is incorporated in its entirety.

### FIELD

The present disclosure generally relates to ingress and egress traffic control over a Transmission Control Protocol/Internet Protocol (TCP/IP) network with a primary and secondary prioritization of traffic.

### BACKGROUND

In electronic communications, especially data transfer amongst computer equipment, many streams of communication are possible to a single device.

In many instances, for example industrial applications, significant amounts of legacy equipment are deployed which utilize dated communications protocols and communications ports. This often problematic, as multiple computers or other devices may request simultaneous access to the legacy equipment.

One existing solution to the problem as known to persons having ordinary skill in the art is to replace dated equipment with new equipment utilizing updated communications protocols. Often, however, this solution is cost prohibitive when thousands of pieces of legacy equipment exist.

The present disclosure addresses the above deficiencies by providing a system and a method, implementable with software or hardware which enables a simple, binary priority to be established for incoming communications.

### SUMMARY OF THE INVENTION

The embodiments of the present disclosure generally relate to a system and a method, implementable with software or hardware, which enables a simple priority to be established for incoming communications. Specifically, the system and method deal with TCP/IP communications and creating a binary gateway protocol therefor.

### BRIEF DESCRIPTION OF THE DRAWINGS

The detailed description will be better understood in conjunction with the accompanying drawings as follows:

FIG. 1 is a flow diagram illustrating the operation of embodiments of the method and system of the present disclosure.

FIG. 2 is a flow diagram illustrating a specific embodiment of the present disclosure.

FIG. 3 is a flow diagram illustrating the operation of embodiments of the method and system of the present disclosure.

The embodiments of the present disclosure are detailed below with reference to the listed Figures.

### DETAILED DESCRIPTION OF THE EMBODIMENTS

Before explaining the present disclosure in detail, it is to be understood that the disclosure is not limited to the specifics of particular embodiments as described and that it can be practiced, constructed, or carried out in various ways.

While embodiments of the disclosure have been shown and described, modifications thereof can be made by one skilled in the art without departing from the spirit and teachings of the disclosure. The embodiments described herein are exemplary only, and are not intended to be limiting.

Specific structural and functional details disclosed herein are not to be interpreted as limiting, but merely as a basis of the claims and as a representative basis for teaching persons having ordinary skill in the art to variously employ the present embodiments. Many variations and modifications of embodiments disclosed herein are possible and are within the scope of the present disclosure.

Where numerical ranges or limitations are expressly stated, such express ranges or limitations should be understood to include iterative ranges or limitations of like magnitude falling within the expressly stated ranges or limitations.

The use of the word “a” or “an” when used in conjunction with the term “comprising” in the claims and/or the specification may mean “one,” but it is also consistent with the meaning of “one or more,” “at least one,” and “one or more than one.”

The word “about”, when referring to values, means plus or minus 5% of the stated number.

The use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, and the like.

When methods are disclosed or discussed, the order of the steps is not intended to be limiting, but merely exemplary unless otherwise stated.

Accordingly, the scope of protection is not limited by the description herein, but is only limited by the claims which follow, encompassing all equivalents of the subject matter of the claims. Each and every claim is hereby incorporated into the specification as an embodiment of the present disclosure. Thus, the claims are a further description and are an addition to the embodiments of the present disclosure.

The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

The embodiments of the present disclosure generally relate to a system and a method, implementable with software or hardware, which enables a simple priority to be established for incoming communications. Specifically, the system and method deal with TCP/IP communications and creating a binary gateway protocol therefor.

The method of implementing a binary gateway protocol on a target connection to prioritize incoming communications can comprise the steps of: receiving data on a device in electronic communication with the target connection, wherein the device has a first incoming port and a second incoming port, allowing data received by the first incoming port to flow through the first incoming port as long as no data is received by the second incoming port, halting data flow through the first incoming port if data is received by the second incoming port and allowing data to flow through the second incoming port, and allowing data to flow through the first incoming port once data ceases to be received by the second incoming port.

In embodiments the method can be implemented via a software, a hardware, or a firmware.

The data can be preconfigured to be received by the first incoming port or the second incoming port. For example, all routine communications to a field device can be preconfigured to be received by the first incoming port for day-to-day operations. However, emergency system communications can be preconfigured to be received by the second incoming port. Therefore, whenever there is any emergency system communication, the data being receive by the first incoming port can be halted from being delivered to the target connection, and the data being delivered to the second incoming port is allowed to flow through to the target connection.

In embodiments, the method can include the step of decrypting data when received, encrypting data when allowed to flow to the target connection, or both steps.

The present disclosure also encompasses a system to implement the above method.

The system can have a receiver for receiving electronic communication, wherein the receiver comprises a first incoming port and a second incoming port, a computer processor, a non-transitory data storage medium, and a transmitter for sending electronic communications.

The non-transitory data storage medium can have computer instructions instructing the computer processor to implement the steps of the disclosed method.

For example, the steps can include the steps to: receive data on either the first incoming port or the second incoming port, forward data received by the first incoming port as long as there is no received by the second incoming port, block data received by the first incoming port and forward data received by the second incoming port when data is received by the second incoming port, and forward data received by the first incoming port once there is no longer data received by the second incoming port. In embodiments, a delay can be implements prior to resuming forwarding of data from the first incoming port.

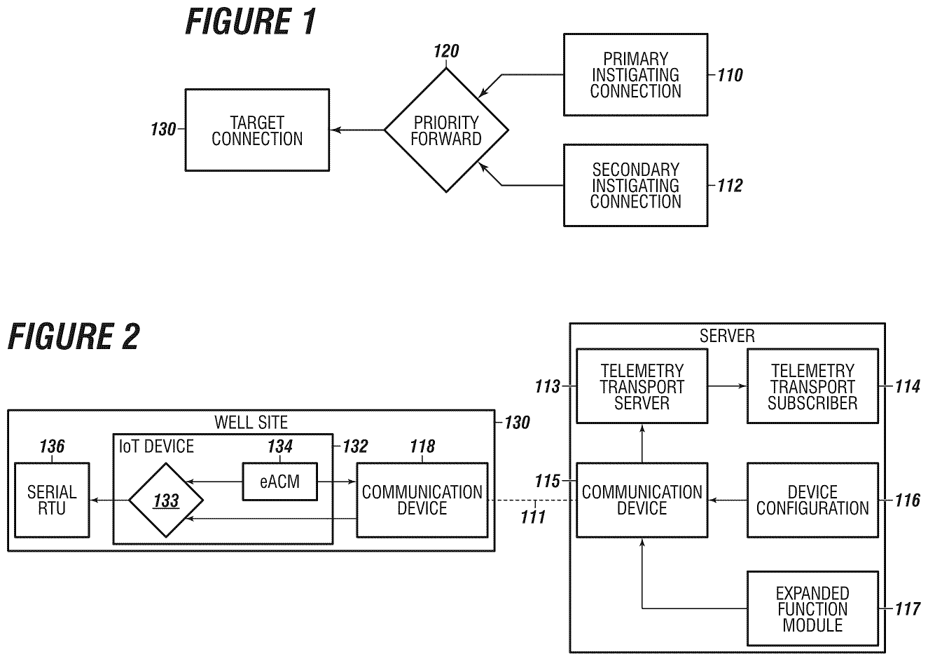

Turning now to the Figures, FIG. 1 is a flow diagram illustrating the operation of embodiments of the method and system of the present disclosure.

Shown here are a primary instigating connection 110 and a secondary instigating connection 112. Both connections are in electronic communication with a priority forward embodiment 120 of the present disclosure. The priority forward embodiment 120 knows which of the instigating connections has a higher priority based upon which incoming port the communication from the instigating connection is being received in.

Priority forward 120 selectively forwards electronic communications to a target connection 130, such as an internet of things (IoT) device. In this embodiment, the secondary instigating connection 112 communicates through secondary priority port of the priority forward embodiment 120. Primary instigating connection 110 attempts to connect to target connection 130. At this point, the priority forward embodiment 120 blocks the communication from secondary instigating connection 112, and allows communication from primary instigating connection 110 through to target connection 130.

Upon primary instigating connection 110 finishing communication, the priority forward embodiment 120 can wait for a user determined period of time. The priority forward embodiment 120 can then allow communication from secondary instigating connection 112.

FIG. 2 is a flow diagram illustrating a specific embodiment of the present disclosure.

Instigating connection 111 is shown to originate here from a server with multiple components, including telemetry transport server 113, telemetry transport subscriber 114, communication device 115 with a device configuration 116, and an expanded function module 117. Instigating connection 111 can utilize communication device 118 to transmit and/or receive communications.

Target connection 130 is shown here as a well site. The target connection 130 can have an internet of things device or IoT device 132 in communication with an eACM 134, also known as Edge AutoSol Communication Manager™ module. Additional module 133 can be included for specific functions. A serial port 136 can be in electronic communication with the IoT device 132.

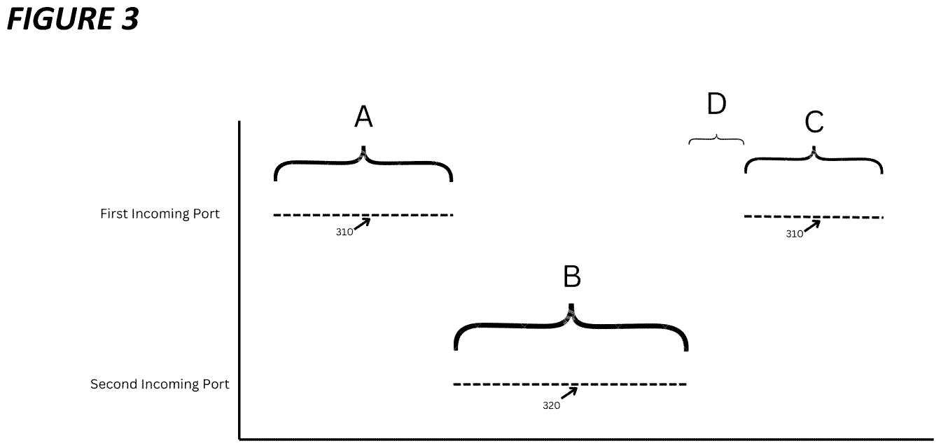

FIG. 3 is a flow diagram illustrating the operation of embodiments of the method and system of the present disclosure.

FIG. 3 illustrates the various time periods and the actions of the binary incoming ports.

Shown are the signals vs time for the first incoming port and the second incoming port.

Time period A illustrates the normal, day-to-day operation of the system. Data or signal 310 is being received by the first incoming port, and is passed through to the target connection.

Time period B illustrates that data or signal 320 is being received on second incoming port. Because second incoming port has a higher priority, data or signal 310 is blocked for time period B and data or signal 320 is passed through to the target connection.

Upon cessation of data or signal 320 in time period C, data or signal 310 is passed through to the target connection. In embodiments, a delay, as shown by time period D can be implemented prior to data or signal 310 being passed through to the target connection.

While the present disclosure emphasizes the presented embodiments and Figures, it should be understood that within the scope of the appended claims, the disclosure might be embodied other than as specifically enabled herein.

What is claimed is:

1. A method of implementing a binary gateway protocol on a target connection to prioritize incoming communications comprising:
a. receiving data on a device in electronic communication with the target connection, wherein the device has a first incoming port and a second incoming port;
b. allowing data received by the first incoming port to flow through the first incoming port as long as no data is received by the second incoming port;
c. halting data flow through the first incoming port if data is received by the second incoming port and allowing data to flow through the second incoming port; and
d. allowing data to flow through the first incoming port once data ceases to be received by the second incoming port.

2. The method of claim 1, wherein the method is implemented via a software, a hardware, or a firmware.

3. The method of claim 1, wherein data is preconfigured to be received by the first incoming port or the second incoming port.

4. The method of claim 1, further comprising the step of decrypting data.

5. The method of claim 1, further comprising the step of encrypting data prior to allowing data to flow through the first incoming port or the second incoming port.

6. A system to implement the method of claim 1, comprising:
a. a receiver for receiving electronic communication, wherein the receiver comprises a first incoming port and a second incoming port;
b. a computer processor;
c. a non-transitory data storage medium; and
d. a transmitter for sending electronic communications.

7. The system of claim 6, wherein the non-transitory data storage medium comprises computer instructions instructing the computer processor to:
a. receive data on either the first incoming port or the second incoming port;
b. forward data received by the first incoming port as long as there is no received by the second incoming port;
c. block data received by the first incoming port and forward data received by the second incoming port when data is received by the second incoming port; and
d. forward data received by the first incoming port once there is no longer data received by the second incoming port.
